(19) United States
(12) Patent Application Publication
(10) Pub. No.: US 2026/0126055 A1
(43) Pub. Date: May 7, 2026

(54) AXIAL FLUX MOTOR PUMP

(71) Applicant: COAVIS CO., LTD., Sejong-Si (KR)

(72) Inventors: Hyuntae LEE, Sejong-Si (KR); Seongjin SON, Ulsan (KR)

(73) Assignee: COAVIS CO., LTD., Sejong-Si (KR)

(21) Appl. No.: 19/376,936

(22) Filed: Nov. 1, 2025

(30) Foreign Application Priority Data
Nov. 4, 2024 (KR) 10-2024-0154166

(51) Int. Cl. F04D 29/42; F04D 13/06; F04D 29/08

(52) U.S. Cl. CPC F04D 29/426; F04D 13/0666; F04D 13/0693; F04D 29/086

(57) ABSTRACT

A motor pump according to the present disclosure includes a housing; an impeller mounted on the housing. A magnet is mounted on the impeller and is positioned to form a magnetic flux parallel to a rotating shaft of the impeller. The motor pump further includes a circuit board having a coil pattern formed thereon that generates the magnetic flux parallel to the rotating shaft by electrical control to interact with the magnet, in which the impeller includes a lower shroud formed at a lower portion of a blade, and the lower shroud has a shroud extension that extends to a radius greater than an outermost radius of the blade to form a lower surface of a volute.

### BACKGROUND

### 1. Field

The present disclosure relates to a motor pump.

### 2. Description of Related Art

A motor pump is a fluid machine in which a motor that converts electrical energy into mechanical energy and a pump that moves fluid using driving force of the motor are combined.

In the automotive industry, motor pumps are used in a variety of systems and play a crucial role in improving vehicle performance and fuel efficiency, reducing emissions, etc. Compared to a pump that uses driving force of an engine, the motor pumps produce less noise and vibration, and are environmentally friendly because they use electric energy. With the advent of electric and autonomous vehicles, the motor mounted on vehicles pumps have expanded their applications to various systems, including a cooling system, a cooling and heating system, a fuel supply system, an oil supply system, a braking system, a steering system, etc.

The pump varies in structure and operating principle, and the electric motor, which is another key component constituting the motor pump, may adopt an axial flux motor (AFM), which offers advantages in terms of efficiency, output, and weight reduction, in addition to a conventional radial flux motor (RFM).

### RELATED PRIOR ART

WO 2023-082002 A1 (Published on 2023 May 19.)
U.S. Pat. No. 10,141,804 B2 (Registered on 2018 Nov. 27.)
KR 10-1237023 B1 (Published on 2013 Feb. 19.)

### SUMMARY

The present disclosure is to improve fluid efficiency by applying an axial flux motor, which offers advantages in terms of efficiency and weight reduction, while improving the design of a stationary surface and rotating adjacent surfaces surrounding an impeller.

In addition, the present disclosure provides an axial flux motor pump that simplifies parts and design, reduces the possibility of defects or damage, and facilitates weight reduction by eliminating a cover plate that is a fluid element installed around an impeller.

The problems discussed in the present disclosure are not limited to those described herein, and other technical problems may be clearly understood by those skilled in the art from the following description.

According to an aspect of the present disclosure, a motor pump includes: a housing; an impeller mounted on the housing; a magnet mounted on the impeller and disposed to form a magnetic flux in a direction parallel to a rotating shaft of the impeller; and a circuit board having a coil pattern formed thereon that generates the magnetic flux parallel to the rotating shaft by electrical control to interact with the magnet, in which the impeller includes a lower shroud formed at a lower portion of a blade, and the lower shroud has a shroud extension that extends to a radius greater than an outermost radius of the blade to form a lower surface of a volute.

The shroud extension may be integrally formed of the same material as the lower shroud.

The shroud extension may be formed to have an outer diameter greater than an outer diameter of the volute formed around the blade.

The housing may include a first inner surface for forming the volute and a second inner surface formed horizontally outward from a lower end of the first inner surface, and a horizontal gap through which fluid passes may be formed between an upper surface of the shroud extension and a second inner surface.

The impeller may further include an upper shroud covering the blade, and the shroud extension may be formed to have a radius greater than an outer diameter of the upper shroud.

The motor pump may further include: a partition plate disposed at an upper portion of the circuit board and configured to block fluid toward a lower portion of the circuit board.

The magnet may be disposed only between the impeller and the partition plate.

The magnet may be integrally attached to the impeller by overmolding.

An extension body may be formed at a lower portion of the impeller to fix the magnet, and a key-shaped part may be provided between the extension body and the magnet to prevent the magnet from rotating.

The extension body may include a reverse-tapered part whose diameter increases toward the lower portion.

The motor pump may further include: a first yoke disposed between the magnet and the lower shroud.

The magnet may have an outer diameter equal to the outer diameter of the shroud extension.

According to another aspect of the present disclosure, a motor pump includes: an upper housing having an inlet formed at a central portion and an outlet formed at an edge; an impeller housed in the upper housing; a magnet mounted at a lower portion of the impeller and disposed to form a magnetic flux parallel to a rotating shaft of the impeller; a circuit board having a coil pattern formed thereon that generates the magnetic flux parallel to the rotating shaft by electrical control to interact with the magnet; and a lower housing coupled to the upper housing and formed so that the circuit board is installed, in which the impeller includes a lower shroud formed at a lower portion of a blade, and the lower shroud has a shroud extension that extends to a radius greater than an outermost radius of the blade to form a lower surface of a volute.

### BRIEF DESCRIPTION OF DRAWINGS

FIG. 1 is a schematic perspective view of an appearance of a motor pump according to an embodiment of the present disclosure.

FIG. 2 is an exemplary longitudinal cross-sectional view of the motor pump of FIG. 1.

FIG. 3 is an exemplary exploded perspective view of the motor pump of FIG. 1.

FIG. 4 is a separated exploded perspective view for describing an impeller and rotor assembly of the present disclosure.

FIG. 5 is an enlarged cross-sectional view of a portion of the motor pump of FIG. 2.

FIG. 6 is a conceptual diagram for describing a cooling action by fluid when the motor pump related to the present disclosure operates.

### DETAILED DESCRIPTION

The following describes a motor pump related to the present disclosure in detail with reference to the accompanying drawings in various aspects. The items illustrated in the drawings serves as a convenient representation of the present disclosure and may not correspond to actual dimensions. In certain cases, sizes or thickness may be exaggerated or better emphasize specific features and characteristics of the invention.

The present disclosure is not limited to the configurations and methods outlined in the described embodiments. The embodiments may be adapted in various ways to manners to yield equivalent alternatives that may be replaced, and all or part of the embodiments may be selectively combined and arranged as appropriate.

The terms used in this specification and the following claims may not be limited to their conventional dictionary meanings, but may be appropriately defined and understood to best describe the present disclosure. The terms “comprises” or “consists of,” as used herein, denote the inclusion of a combination of elements, components, or steps, and do not preclude the possibility of incorporating additional elements, components, or steps. Where a specific component is referred to as being “connected” or “coupled” to another, it should be understood that the components may be directly connected or coupled to each other, or indirectly connected or coupled to each other with one or more other components interposed therebetween. Conversely, when a specific component is described as “directly connected” or “directly coupled,” this indicates that there is no other component present between the components.

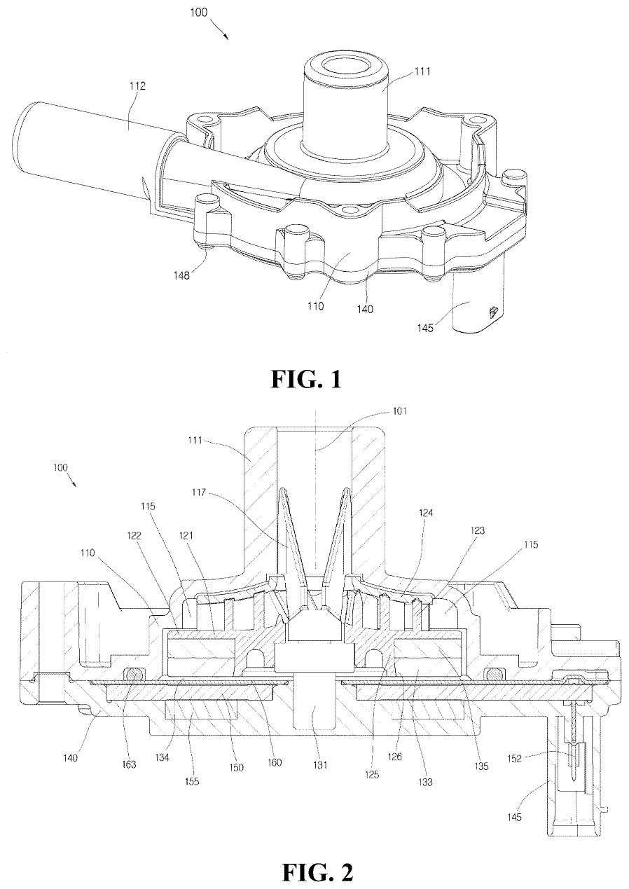

FIG. 1 schematically illustrates an appearance of an exemplary motor pump 100 according to the present disclosure. The illustrated motor pump 100 is formed as an assembly of an upper housing 110 and a lower housing 140, which generally have a disc-shaped appearance. Here, the terms “upper portion” and “lower portion” are conveniently named with reference to FIG. 1. When the motor pump 100 is actually mounted on an application object, the direction and position of the motor pump 100 may differ. The fluid pumped through the motor pump 100 may be a liquid. In the present disclosure, the motor pump 100 for pumping liquid water will be primarily described. An exemplary application target of such a motor pump 100 may be a vehicle thermal management system or a coolant circulation pump for achieving the same.

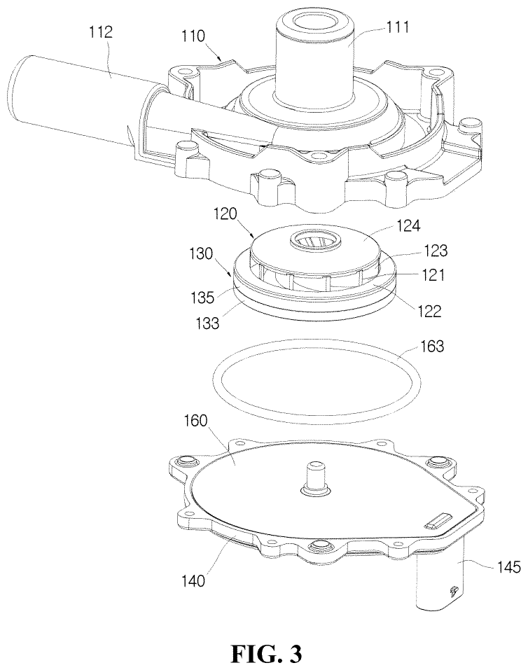

The upper housing 110 may have an inlet 111 disposed at a central side and an outlet 112 disposed at an edge. Since the inlet 111 is disposed vertically penetrating through the upper housing 110 and the outlet 112 is formed tangentially around the upper housing 110, the motor pump 100 may be configured in a form suitable for applying a centrifugal impeller 120 inside (see FIGS. 2 and 3).

The lower housing 140 may be relatively thin compared to a vertical width of the upper housing 110 to house an installation space for the inlet 111, the outlet 112, and internal parts for pumping. This is not only due to the adoption of an axial flux motor but also to a single rotor presented as an exemplary embodiment according to the present disclosure, which allows the overall vertical width to be reduced by that amount.

A terminal 145 for connecting an external cable for power supply and control is provided on one edge of the lower housing 140.

The upper housing 110 and the lower housing 140 may be fastened by a plurality of screws 148 disposed along the edge. In addition to or instead of fastening by the screw 148, a joint structure by fusion (e.g., laser fusion, ultrasonic fusion) of the upper housing 110 and the lower housing 140 may also be applied.

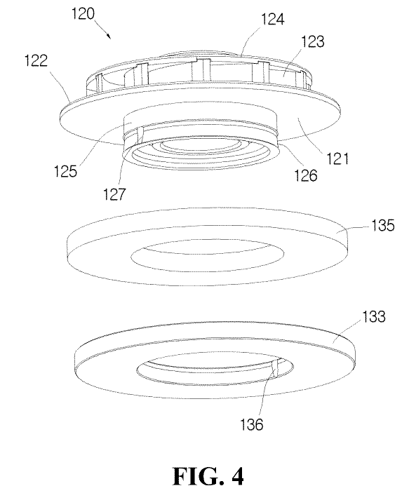

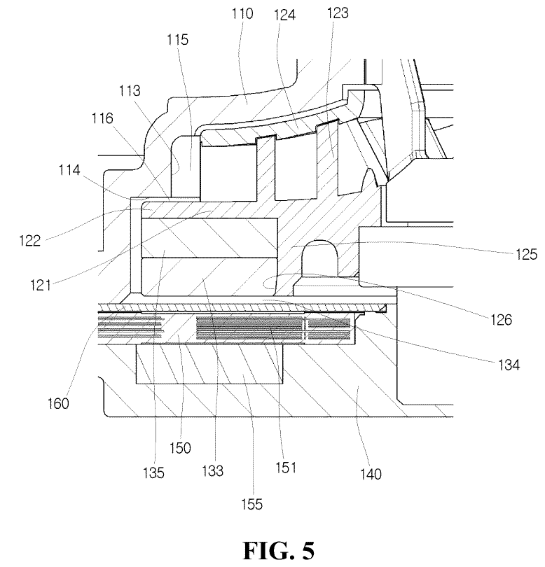

To describe the internal configuration of the motor pump 100 related to the present disclosure, reference will be made to the cross-sectional views of FIGS. 2 and 5 and the exploded perspective views of FIGS. 3 and 4.

As illustrated in these drawings, the impeller 120 is housed within the upper housing 110. The impeller 120 may have a lower shroud 121 having a blade 123 formed therein, and an upper shroud 124 covering the blade 123. Depending on the design requirements, the upper shroud 124 may be removed, and the present disclosure may be applied in this case as well. The detailed shape and disposition of the blade 123 may be known, and a detailed description thereof will be omitted for brevity.

The upper housing 110 includes a first inner surface 113 formed with a radius that gradually increases with a rotation angle from an outermost side of the blade 123 to form a volute 115 on the outer side of the blade 123. The exemplary first inner surface 113 may be a vertical surface, or a curved surface with a radius that varies depending on a height. In this embodiment, the first inner surface 113 is illustrated as being formed as a vertical surface.

As the design improvement in this embodiment, the lower shroud 121 has a shroud extension 122 that extends to have a radius greater than an outermost radius from the rotating shaft 101 of the blade 123 to form the lower surface of the volute 115. This shroud extension 122 may be integrally formed of the same material as the lower shroud 121. That is, the shroud extension 122 and the lower shroud 121 are integrally formed as a single part by molding a single material (resin or metal).

The shroud extension 122 may have an outer diameter greater than an outer diameter of the volute 115. Accordingly, the shroud extension 122, which is a rotating element, functions as a cover for the lower portion of the fluid guided through the volute 115. This contrasts with a configuration in which a separate member, such as a ring or plate, rather than the shroud extension 122, is attached to the upper housing 110, thereby contributing to the simplification of not only the parts and manufacturing process but also the overall design.

The shroud extension 122 is formed to allow a portion of the fluid collected in the volute 115 to circulate to the lower portion of the impeller 120. To this end, as illustrated in FIG. 5, the upper housing 110 may include a second inner surface 114 formed horizontally in an outward direction from a lower end of a first inner surface 113. A horizontal gap 116 is formed between the second inner surface 114 and the upper surface of the shroud extension 122 so that some of the fluid of the volute 115 may pass through and flow to the lower portion of the impeller 120.

A rotor 130 is restrainedly mounted on the impeller 120 so as to generate a magnetic flux in a direction parallel to the rotating shaft 101 of the impeller 120. Referring to FIG. 3, the rotor 130 is directly coupled to the impeller 120 and is integrally formed. To this end, as illustrated in FIG. 4, the impeller 120 may have an extension body 125 in the lower portion of the lower shroud 121, and a first yoke 135 and a magnet 133 are installed in the extension body 125. The magnet 133 is disposed to form a magnetic flux in a direction parallel to the rotating shaft 101, as described above, in terms of the magnetic field. In terms of the shape, the magnet 133 may be in the form of the ring into which the extension body 125 may be inserted or filled. The magnet 133 may include a permanent magnet. In order to integrally manufacture the impeller 120 and the rotor 130, the magnet 133 may be coupled to the impeller 120 together with the first yoke 135 by an overmolding method. In order to maintain the magnet 133 and the first yoke 135 in a firmly fixed state with respect to the extension body 125 and the lower shroud 123, the extension body 125 may include a reverse-tapered part 126 whose diameter increases toward the lower portion. In addition, key-shaped parts 127 and 136 may be disposed between the extension body 125 and the magnet 133 to prevent the magnet 133 from rotating. These key-shaped parts 127 and 136 may include a structure of protrusions and grooves, and may be disposed at a plurality of opposing positions with respect to rotating shaft 101.

One idea of the present disclosure utilizes the fact that the diameter of the magnet 133 may be increased by the same amount as the diameter enlarged by the shroud extension 122, thereby achieving a more efficient motor in a limited space. To this end, the magnet 133 may have the same outer diameter as the shroud extension 122. Accordingly, the diameter of the first yoke 135 may also be formed to be equal to the diameter of the magnet 133.

A shaft 131 may be mounted on the upper housing 110 or the lower housing 140 to rotatably support the impeller 120 and rotor 130. Additionally, a support 117 may be formed on an inner wall of the inlet 111 to stably support the impeller 120.

The lower housing 140 houses a circuit board 150 having a coil pattern 151 (see FIG. 5) formed thereon, in which the coil pattern 151 may generate a magnetic flux parallel to the rotating shaft 101 to interact with a magnet 133 by electrical control. The coil pattern 151 may be laminated in multiple layers within the circuit board 150, and any known planar or three-dimensional winding pattern for magnetic interaction with the magnet 133 may be applied.

Since the circuit board 150 is supplied with power and allows current to flow under control for magnetic interaction with the magnet 133, heat may be generated. Since this heat may reduce the efficiency of the motor pump 100, the motor pump 100 may be configured to dissipate the heat of the circuit board 150 through the fluid pumped through the impeller 120.

As an exemplary embodiment of the present disclosure, a partition plate 160 is installed on the upper portion of the circuit board 150 to block fluid flowing toward the lower portion of the circuit board 150. The partition plate 160 may be formed of a metal capable of rapidly discharging (dissipating) heat from the circuit board 150 into the fluid (water) circulating on the upper surface of the partition plate 160. To facilitate the smooth magnetic interaction between the magnet 133 and the circuit board 150, the partition plate 160 may be formed of a non-magnetic resin or metal. The partition plate 160 may be, for example, polyphenylene sulfide resin (PPS resin) or stainless steel. A sheet or grease having excellent heat transfer properties may be disposed between the partition plate 160 and the circuit board 150.

The partition plate 160 may be firmly attached to the lower housing 140 to prevent the fluid (water) from penetrating into the upper surface. An exemplary attachment method is to fuse the partition plate 160 to the lower housing 140. This fusion may be accomplished using a laser or ultrasonic fusion method.

A second yoke 155 may be disposed on the lower surface of the circuit board 150 to improve the magnetic interaction between the magnet 133 and the coil pattern 151. The lower housing 140 may be sealed by the partition plate 160 with the circuit board 150 and the second yoke 155 disposed therein. The assembly of the lower housing 140 may be attached to the upper housing 110 by fusion along the fused part 147 of the edge. The laser fusion or ultrasonic fusion may be applied as the exemplary methods. In the case of the laser fusion, the upper housing 110 or the lower housing 140 may be formed of a transparent or semi-transparent material to allow the laser to pass through. Additionally, the lower housing 140, the circuit board 150, the partition plate 160, and the second yoke 155 may be integrally manufactured by the overmolding.

A sealing 163 is disposed between the partition plate 160 and the upper housing 110 to seal the fluid introduced for cooling from the impeller 120. The sealing 163 may be arranged on one or both of the center and edge sides of the partition plate 160.

The magnet 133 directly attached to the impeller 120 is disposed only between the impeller 120 and the partition plate 160, and the motor pump 100, which is an example of the present disclosure, is of a single rotor 130 type. As a result, compared to the method in which the rotor is added to the lower portion of the circuit board 150, not only may the size be reduced by half the thickness of the additional rotor installed, but also there is no possibility of the fluid penetrating into the circuit board 150 through the partition plate 160, so it is free from leakage problems, and compared to the conventional technology that requires the sealing both the terminal and the circuit board, the sealing of the terminal 145 may be omitted, which is advantageous in terms of manufacturing and cost.

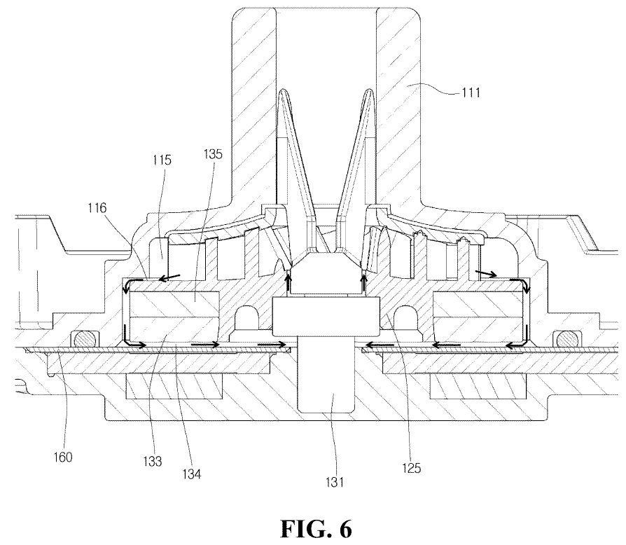

FIG. 6 illustrates the cooling action by the fluid when the motor pump 100 related to the present disclosure operates. The solid arrow indicates that when the motor pump 100 operates, the water in the volute 115 flows to the lower portion along the horizontal gap 116 between the second inner surface 114 and the shroud extension 122, and then flows along the gap 134 between the magnet 133 and the partition plate 160, thereby dissipating the heat from the partition plate 160 and the circuit board 150.

According to an aspect of the motor pump of the present disclosure, a shroud extension having a radius greater than the outermost radius of the blade is formed on the lower shroud. Compared to the conventional case in which the shroud extension forms the lower surface of the volute and a cover plate is installed, the rotating adjacent surfaces with respect to the fixed surface is reduced, thereby improving the hydrodynamic efficiency. The integrated shroud extension reduces the number of parts, while also contributing to weight reduction and design simplification, thereby reducing the possibility of defects or damage.

What is claimed is:

1. A motor pump, comprising:
a housing;
an impeller mounted on the housing;
a magnet mounted on the impeller and disposed to form a magnetic flux parallel to a rotating shaft of the impeller; and
a circuit board having a coil pattern formed thereon that generates the magnetic flux parallel to the rotating shaft by electrical control to interact with the magnet,
wherein the impeller includes a lower shroud formed at a lower portion of a blade, and
wherein the lower shroud has a shroud extension that extends to a radius greater than an outermost radius of the blade to form a lower surface of a volute.

2. The motor pump of claim 1, wherein the shroud extension is integrally formed of a same material as the lower shroud.

3. The motor pump of claim 1, wherein the shroud extension is formed to have an outer diameter greater than an outer diameter of the volute formed around the blade.

4. The motor pump of claim 1, wherein the housing includes a first inner surface for forming the volute and a second inner surface formed horizontally outward from a lower end of the first inner surface, and
a horizontal gap through which fluid passes is formed between an upper surface of the shroud extension and a second inner surface.

5. The motor pump of claim 1, wherein the impeller further includes an upper shroud covering the blade, and
the shroud extension is formed to have a radius greater than an outer diameter of the upper shroud.

6. The motor pump of claim 1, further comprising:
a partition plate disposed at an upper portion of the circuit board and configured to block fluid toward a lower portion of the circuit board.

7. The motor pump of claim 1, wherein the magnet is disposed only between the impeller and a partition plate.

8. The motor pump of claim 1, wherein the magnet is integrally attached to the impeller by overmolding.

9. The motor pump of claim 1, wherein an extension body is formed at a lower portion of the impeller to fix the magnet, and
a key-shaped part is provided between the extension body and the magnet to prevent the magnet from rotating.

10. The motor pump of claim 9, wherein the extension body includes a reverse-tapered part whose diameter increases toward the lower portion.

11. The motor pump of claim 10, further comprising:
a first yoke disposed between the magnet and the lower shroud.

12. The motor pump of claim 11, wherein the magnet has an outer diameter equal to the outer diameter of the shroud extension.

13. A motor pump, comprising:
an upper housing having an inlet formed at a central portion and an outlet formed at an edge;
an impeller housed in the upper housing;
a magnet mounted at a lower portion of the impeller and disposed to form a magnetic flux parallel to a rotating shaft of the impeller;
a circuit board having a coil pattern formed thereon that generates the magnetic flux parallel to the rotating shaft by electrical control to interact with the magnet; and
a lower housing coupled to the upper housing and formed so that the circuit board is installed,
wherein the impeller includes a lower shroud formed at a lower portion of a blade, and
wherein the lower shroud has a shroud extension that extends to a radius greater than an outermost radius of the blade to form a lower surface of a volute.
